(19) United States
(12) Patent Application Publication
(10) Pub. No.: US 2025/0021865 A1
(43) Pub. Date: Jan. 16, 2025

(54) BI-LEVEL FINETUNING WITH TASK-DEPENDENT SIMILARITY STRUCTURE FOR LOW-RESOURCE TRAINING

(71) Applicant: TENCENT AMERICA LLC, Palo Alto, CA (US)

(72) Inventor: Lifeng JIN, Palo Alto, CA (US)

(73) Assignee: TENCENT AMERICA LLC, Palo Alto, CA (US)

(21) Appl. No.: 18/347,716

(22) Filed: Jul. 6, 2023

(51) Int. Cl. G06N 20/00

(52) U.S. Cl. CPC G06N 20/00

(57) ABSTRACT

There is included a method and apparatus comprising computer code configured to cause a processor or processors to constructing similarity scores between words, initializing a similarity structure which is task-dependent and based on the similarity scores, and machine learning a task-dependency of the similarity structure by implementing bi-level optimization including a search phase comprising learning model weights by estimating a parameter of a model, respective to a first entry of the similarity structure, and learning a parameter of a second entry of the similarity structure by using the parameter on the second entry, and a fine-tuning phase comprising updating the parameter of the model while holding the similarity structure fixed.

### BACKGROUND

### 1. Field

The present disclosure is directed to improved generalization in language model training, without external knowledge, and application thereof without overfitting.

### 2. Description of Related Art

Training a large language model in low-resource settings is recognized as technologically challenging since such model would be susceptible to overfitting and with limited generalization abilities.

Attempts have been made to address such issues in that deficient technology, unable to simply provide a desired outcome, by approaches such as employing tunable parameters reduction or data augmentation. However, such technical attempts nonetheless limited the trained models' expressiveness or otherwise burdened possible practicality by relying on task-independent knowledge, as such, the technology was unable to simply achieve the desired outcomes even after application of much technological effort.

For example, low-resource training has been a challenging but important task in natural language processing, and approaches have been proposed to tackle the issues encountered in low-resource training. Robust finetuning methods have been attempted in such training scenarios, such as approaches restricting tunable parameters and noise-robust training methods. And even if those attempts could be assumed to alleviate the overfitting problem, but those attempts nonetheless introduce no new information beyond the training data into the model. Further, data augmentation on a token level as well as on a sentence level using syntax, back-translation or generation models are approaches which aims at introducing extra information into model training, and other similar attempts have relied on pseudo-labeling extra data using task insights and heuristics. However, those are generally designed for a specific task, or require external knowledge sources.

Finetuning pretrained large models in low-resource scenarios had previously faced many challenges. One of the challenges is the overfitting of the model when finetuned on the small training data. Different approaches have been proposed to tackle this problem and achieved relatively great results. Some approaches restrict the number of parameters to be updated in the finetuning process to avoid overfitting to small amounts of data. However, parameter restriction while model finetuning may impact the model's expressiveness.

Other methods such as data augmentation aimed at increasing the training data size through synthesizing new training data examples to boost generalization ability. These methods relied on either external lexical resources and heuristics, which are limited in domain and language, or pretrained language models, the semantic similarity space of which is not task-dependent. For example, Apple may be replaced by Microsoft in synonym replacement based on some lexical resource, but the “replace-ability” really depends on whether the task is “separate tech companies from gas companies” or “find companies with their headquarters in Washington state”, the information of which pretrained language models or static lexical resources are not able to provide.

Therefore, there has been an unmet desire for a technological solution to such problems.

### SUMMARY

To address one or more different technical problems, this disclosure provides technical solutions to reduce network overhead and server computational overheads while delivering immersive video with respect to one or more viewport margin updates according to exemplary embodiments.

There is included a method and apparatus comprising memory configured to store computer program code and a processor or processors configured to access the computer program code and operate as instructed by the computer program code. The computer program includes constructing code configured to cause the at least one processor to construct similarity scores between words, initializing code configured to cause the at least one processor to initialize a similarity structure which is task-dependent and based on the similarity scores, machine learning configured to cause the at least one processor to machine learn a task-dependency of the similarity structure by implementing bi-level optimization including a search phase including learning model weights by estimating a parameter of a model, respective to a first entry of the similarity structure, and learning a parameter of a second entry of the similarity structure by using the parameter on the second entry; and a fine-tuning phase including updating the parameter of the model while holding the similarity structure fixed.

The words may be of a vocabulary of a predetermined size, and the similarity structure may include a similarity matrix having a plurality of rows each being respective to one of the words, a number of the rows being of the predetermined size, and each of the entries, including the first entry and the second entry, to the rows may indicate a proximity of the respective ones of the words to each of other ones of the words.

Estimating the parameter of the model may include learning optimal model weights W*(S) based on:

$${W}^{*} ( S ) = {min}_{W} L ( W , S , {𝒟}^{ℬ - 𝓉𝓇𝒶𝒾𝓃} ) ,$$

where W is the model parameter, S is the similarity matrix, L is a task loss, and [symbol] is a training set.

The similarity matrix S may not be updated while learning the optimal model weights W*(S).

After learning the optimal model weights W*(S), the similarity matrix S may be updated by:

$${min}_{S} L ( {W}^{*} ( S ) , S , {𝒟}^{ℬ - 𝓋𝒶ℓ} ) .$$

where [symbol] is a validation set.

The computer program code may further include reducing code configured to cause the at least one processor to, after initializing the similarity structure, reduce a dimension of the similarity structure based on a number of the words determined to have highest similarity scores as compared to other ones of the words.

The computer program code may further include reducing code configured to cause the at least one processor to, after initializing the similarity structure, reduce a dimension of the similarity structure by decomposing the similarity matrix into a product of a plurality of matrices.

Initializing the similarity structure may include adding an inner product of an embedding matrix to another matrix, and the embedding matrix may include a hidden dimension of an embedding layer of a language model comprising the embedding matrix.

Initializing the similarity structure may include deriving soft embeddings of the words, and the soft embeddings comprise linear combinations of embedding vectors having weights determined based on the similarity structure.

The computer program code may further include receiving code, configured to case the at least one processor to receive a task, and answering code configured to case the at least one processor to answer the task based on the task-dependency of the similarity structure machine-learned by implementing the bi-level optimization.

### BRIEF DESCRIPTION OF THE DRAWINGS

Further features, nature, and various advantages of the disclosed subject matter will be more apparent from the following detailed description and the accompanying drawings in which:

FIG. 1 is a simplified schematic illustration in accordance with embodiments;

FIG. 2 is a simplified schematic illustration in accordance with embodiments;

FIG. 3 is a simplified block diagram in accordance with embodiments;

FIG. 4 is a simplified flow diagram in accordance with embodiments;

FIG. 5 is a simplified illustration in accordance with embodiments; and

FIG. 6 is a schematic illustration in accordance with embodiments.

### DETAILED DESCRIPTION

The proposed features discussed below may be used separately or combined in any order. Further, the embodiments may be implemented by processing circuitry (e.g., one or more processors or one or more integrated circuits). In one example, the one or more processors execute a program that is stored in a non-transitory computer-readable medium.

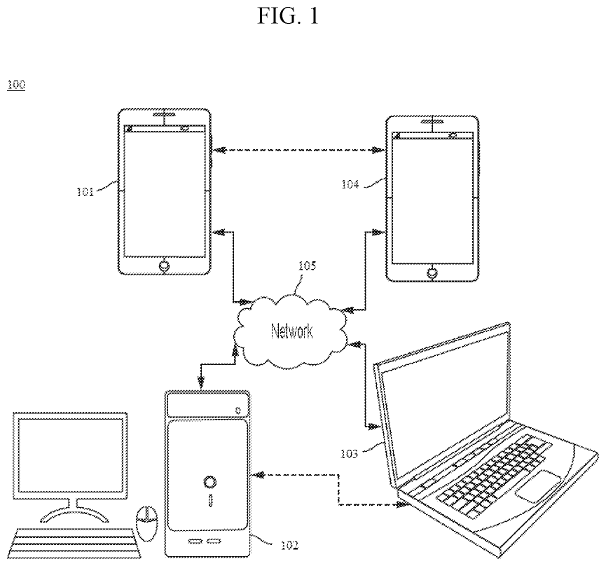

FIG. 1 illustrates a simplified block diagram of a communication system 100 according to an embodiment of the present disclosure. The communication system 100 may include at least two terminals 102 and 103 interconnected via a network 105. For unidirectional transmission of data, a first terminal 103 may code video data at a local location for transmission to the other terminal 102 via the network 105. The second terminal 102 may receive the coded video data of the other terminal from the network 105, decode the coded data and display the recovered video data. Unidirectional data transmission may be common in media serving applications and the like.

FIG. 1 illustrates a second pair of terminals 101 and 104 provided to support bi-directional transmission of coded video that may occur, for example, during videoconferencing. For bidirectional transmission of data, each terminal 101 and 104 may code video data captured at a local location for transmission to the other terminal via the network 105. Each terminal 101 and 104 also may receive the coded video data transmitted by the other terminal, may decode the coded data and may display the recovered video data at a local display device.

In FIG. 1, the terminals 101, 102, 103 and 104 may be illustrated as servers, personal computers and smart phones but the principles of the present disclosure are not so limited. Embodiments of the present disclosure find application with laptop computers, tablet computers, media players and/or dedicated video conferencing equipment. The network 105 represents any number of networks that convey coded video data among the terminals 101, 102, 103 and 104, including for example wireline and/or wireless communication networks. The communication network 105 may exchange data in circuit-switched and/or packet-switched channels. Representative networks include telecommunications networks, local area networks, wide area networks and/or the Internet. For the purposes of the present discussion, the architecture and topology of the network 105 may be immaterial to the operation of the present disclosure unless explained herein below.

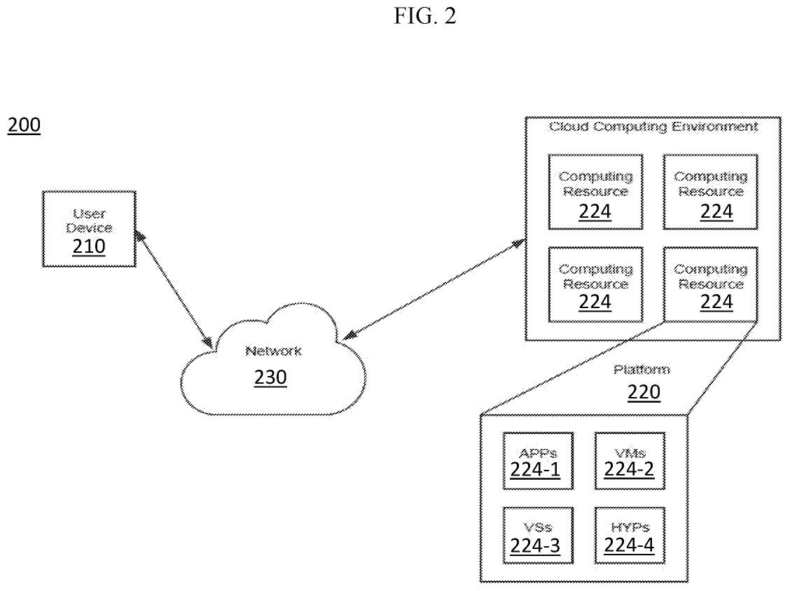

FIG. 2 is a diagram of an environment 200 in which methods, apparatuses and systems described herein may be implemented, according to embodiments. As shown in FIG. 2, the environment 200 may include a user device 210, which may represent any of terminals 101, 102, 103 and 104 according to embodiments, a platform 220, and a network 230. Devices of the environment 200 may interconnect via wired connections, wireless connections, or a combination of wired and wireless connections.

The user device 210 includes one or more devices capable of receiving, generating, storing, processing, and/or providing information associated with platform 220. For example, the user device 210 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, the user device 210 may receive information from and/or transmit information to the platform 220.

The platform 220 includes one or more devices as described elsewhere herein. In some implementations, the platform 220 may include a cloud server or a group of cloud servers. In some implementations, the platform 220 may be designed to be modular such that software components may be swapped in or out depending on a particular need. As such, the platform 220 may be easily and/or quickly reconfigured for different uses.

In some implementations, as shown, the platform 220 may be hosted in a cloud computing environment 222. Notably, while implementations described herein describe the platform 220 as being hosted in the cloud computing environment 222, in some implementations, the platform 220 may not be cloud-based (i.e., may be implemented outside of a cloud computing environment) or may be partially cloud-based.

The cloud computing environment 222 includes an environment that hosts the platform 220. The cloud computing environment 222 may provide computation, software, data access, storage, etc. services that do not require end-user (e.g., the user device 210) knowledge of a physical location and configuration of system(s) and/or device(s) that hosts the platform 220. As shown, the cloud computing environment 222 may include a group of computing resources 224 (referred to collectively as “computing resources 224” and individually as “computing resource 224”).

The computing resource 224 includes one or more personal computers, workstation computers, server devices, or other types of computation and/or communication devices. In some implementations, the computing resource 224 may host the platform 220. The cloud resources may include compute instances executing in the computing resource 224, storage devices provided in the computing resource 224, data transfer devices provided by the computing resource 224, etc. In some implementations, the computing resource 224 may communicate with other computing resources 224 via wired connections, wireless connections, or a combination of wired and wireless connections.

As further shown in FIG. 2, the computing resource 224 includes a group of cloud resources, such as one or more applications (“APPs”) 224-1, one or more virtual machines (“VMs”) 224-2, virtualized storage (“VSs”) 224-3, one or more hypervisors (“HYPs”) 224-4, or the like.

The application 224-1 includes one or more software applications that may be provided to or accessed by the user device 210 and/or the platform 220. The application 224-1 may eliminate a need to install and execute the software applications on the user device 210. For example, the application 224-1 may include software associated with the platform 220 and/or any other software capable of being provided via the cloud computing environment 222. In some implementations, one application 224-1 may send/receive information to/from one or more other applications 224-1, via the virtual machine 224-2.

The virtual machine 224-2 includes a software implementation of a machine (e.g., a computer) that executes programs like a physical machine. The virtual machine 224-2 may be either a system virtual machine or a process virtual machine, depending upon use and degree of correspondence to any real machine by the virtual machine 224-2. A system virtual machine may provide a complete system platform that supports execution of a complete operating system (“OS”). A process virtual machine may execute a single program, and may support a single process. In some implementations, the virtual machine 224-2 may execute on behalf of a user (e.g., the user device 210), and may manage infrastructure of the cloud computing environment 222, such as data management, synchronization, or long-duration data transfers.

The virtualized storage 224-3 includes one or more storage systems and/or one or more devices that use virtualization techniques within the storage systems or devices of the computing resource 224. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

The hypervisor 224-4 may provide hardware virtualization techniques that allow multiple operating systems (e.g., “guest operating systems”) to execute concurrently on a host computer, such as the computing resource 224. The hypervisor 224-4 may present a virtual operating platform to the guest operating systems, and may manage the execution of the guest operating systems. Multiple instances of a variety of operating systems may share virtualized hardware resources.

The network 230 includes one or more wired and/or wireless networks. For example, the network 230 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the environment 200 may perform one or more functions described as being performed by another set of devices of the environment 200.

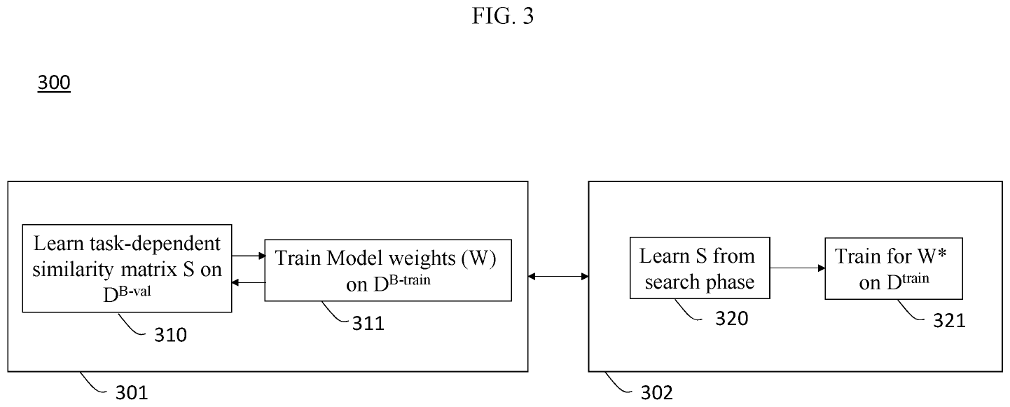

FIG. 3 illustrates an example 300, a high level overview of what may be understood as Bi-level Finetuning with Task-dependent Similarity Structure (or “BFTSS”), the “bi-level”, being a search phase using bi-level optimization (or “search phase”) 301 at one level and a fine-tuning phase 302 of the other level of that bi-level structure. As discussed throughout this disclosure, a “search phase”, such as of the search phase 301, regards using soft embeddings from a task-dependent similarity structure, or similarity matrix S, to update all parameters and pass task dependent knowledge to learn that task-dependent similarity structure (similarity matrix S), and a “fine-tuning phase”, such as of the fine-tuning phase 302, may use soft embeddings from the learned task-dependent similarity structure (similarity matrix S) to update all parameters.

For example, a Bi-level Finetuning with Task-dependent Similarity Structure, according to exemplary embodiments, centers around learning and utilizing a task-dependent similarity structure, the similarity matrix S. The similarity matrix S may be first initialized and learned at process 310 along with model parameters with bi-level optimization on task data, where soft embeddings of words are derived from the structure to propagate training signals into unseen words. After this first phase of training, named search phase, a fine-tuning phase, such as of the fine-tuning phase 302, follows in which only model parameters are updated with the similarity structure fixed, which is discussed further below.

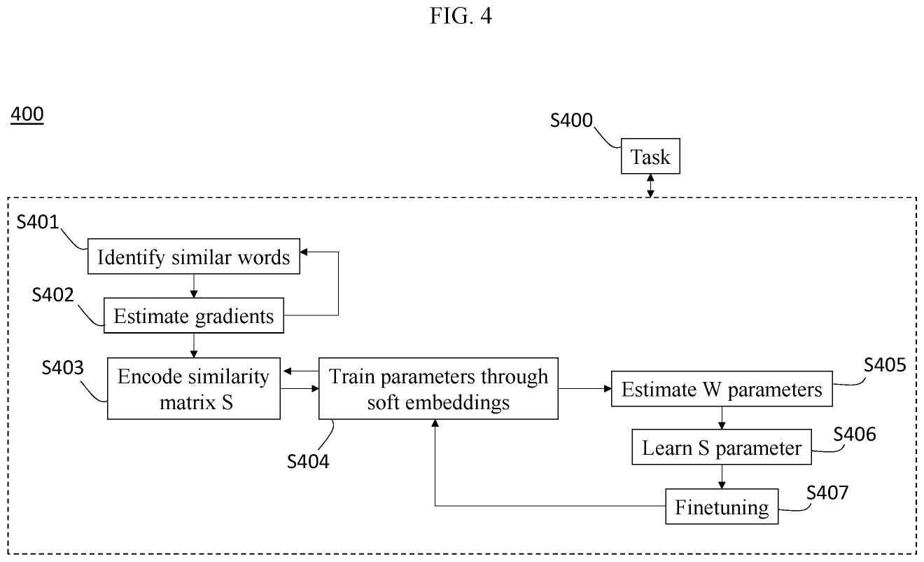

According to example embodiments of the BFTSS, a task-dependent similarity structure S may be first learned with a small training data, 10100 data samples for example, and then used to improve the performance of the language models. The motivation for the task-dependent similarity structure comes from the observation that only a few words appear in the training data in a low-resource scenario with their word embeddings updated in training. However, disclosed herein are embodiments to achieve the effect of passing more information about the unseen words to the model to train it. For example, embodiments herein employ identifying a word's similar words in the vocabulary, as with a thesaurus or the like, and estimating gradients of those similar words from the seen words gradient. This similarity structure is encoded as a similarity matrix S, with each row corresponding to a word in the vocabulary with size V. See process 310 in FIG. 3 and corresponding step S401 where there is identify similar words, at S402 there is estimate gradients, and at step S403 there is an encoding of the similarity matrix S in the exemplary flowchart 400 of FIG. 4. According to an embodiment, the row entries represent the task-dependent semantic proximity of a word with all other words in the vocabulary.

According to exemplary embodiments, all parameters may be trained through soft embeddings with a task-specific similarity structure. See process 311 in FIG. 3 and step S404 in FIG. 4 for example. Herein, soft embeddings are defined as a linear combination of the embedding vectors weighted by the entries of the similarity matrix S. Intuitively, such features mean that when a model with parameters W sees a word in the text input, it also sees all the related words weighted by the entries of the corresponding row in S. Thus the optimal model weights learned this way would be dependent on S, i.e., W*(S).

For training the similarity matrix S, which is task-dependent, rather than learning the similarity matrix S by reducing the training loss on the model parameters W*(S), since such approach is similar in a sense to adding more parameters to an already huge language model, the similarity matrix S may instead, according to exemplary embodiments, be learned using a bi-level optimization approach. Bi-level optimization is used because of the discovery, disclosed by this application, of a useful inter-dependency between the optimal model weights W* and the optimal similarity matrix S*. For example, the learned optimal model weights W*(S) depend on S and S is learned in a way that further improves the performance of W*(S). This shows that both parameters influence and benefit from each other. With bi-level optimization, embodiments are advantageously able to first estimate the W parameters at S405 by one-step gradient descent with S fixed on one portion of the training data, and learn the S parameter, such as at process 320, by using the learned W parameter on a different portion. This bi-level optimization phase of W and S is called the Search Phase.

Finally, with the learned S and W from the Search Phase, finetuning is conducted at S407 in the Finetuning Phase for further tuning the W parameters on the entire training data. The learned S parameters is fixed throughout the phase.

The similarity structure is encoded at S403 according to exemplary embodiments as a similarity matrix S∈R^{V×V}, where V is the vocabulary size. Each row of the S matrix represents a word in the vocabulary. The row entries represent a word's semantic proximity with all the other words in the vocabulary. One way herein to initialize this S matrix is to add the inner product of the pretrained language model's embedding matrix E∈R^{H×V} with itself (where H is the hidden dimension of the embedding layer of the language model) to the identity matrix:

$$S = α I + ( 1 - α ) f ( {\{ \hat{E} \}}^{d} ) , \qquad Eq . 1$$

where Ê is the normalized E matrix where each column vector is a unit norm vector, d is the inverse temperature, I∈R^{V×V} is the identity matrix, a is trade-off parameter, and f is the normalizing function that normalizes each row to sum to 1. The identity matrix is added to make the initialization a spiky distribution with the highest weight for the diagonal elements. The pretrained model's embedding layer decides the weights of the off-diagonal elements. These language models are pretrained on a huge corpus of texts and the cosine distance between the embedding vectors depict the semantic proximity between the words. The inner-product matrix is raised to the power of inverse temperature and normalized to make it a smooth and light-tailed distribution. a controls how strong the pretrained embeddings influence the similarity values. By setting a to 1, we have Vanilla finetuning where the similarity terms are not considered. According to exemplary embodiments, both terms may be understood to have equal weights.

Soft embeddings are defined herein as the linear combination of all the related embedding vectors whose weights are determined by the similarity matrix [symbol] . Formally, embodiments herein define the soft embedding vector of a word as follows,

$$= {\sum }_{j = 0}^{K} {s}_{i , j}^{( t )} {E}_{j}^{( t )} = {e}_{i}^{( t )} {S}^{( t )} {\{ {E}^{( t )} \}}^{T} \qquad Eq . 2$$

where K is the number of related words used to calculate soft embeddings, E^{(t)} ∈R^{H×V} and S^{(t)} ∈R^{V×V} are the embedding matrix and similarity matrix at t^{th} iteration. Eⱼ^{(t)} is the embedding vector of j^{th} word. s_{i,j}^{(t)} is the {i,j} th element of the S^{(t)} matrix which describes how similar the j-th word is to the i-th word. eᵢ^{(t)} is the one-hot representation of the i-th word and [symbol] is the soft embedding of it.

When the model weights are updated with back-propagation, such as at process 310 and process 311, the embeddings of all the similar words (determined by the entries of the similarity matrix S) are updated, propagating task knowledge into all parts of the model:

$$∇ {e}_{i} = {\sum }_{j = 0}^{K} {s}_{ij}^{( t )} ∇ {E}_{j}^{( t )} . \qquad Eq . 3$$

Because the similarity structure needs to be trained with task data, a bi-level optimization-based approach disclosed herein for learning such a task-dependent similarity structure.

There are two stages in the bi-level learning process. As described above, in the first stage, the model weights W is updated to minimize the loss on one dataset, searching for the optimal model weights W*(S) on that dataset. In the second stage, the task-dependent similarity matrix S is updated searching for S* that attains the minimum loss on a different dataset.

In the first stage, model parameters W are trained at process 311 on BFTSS training set [symbol] with the similarity matrix S fixed:

$${W}^{*} ( S ) = {min}_{W} L ( W , S , {𝒟}^{B - 𝓉𝓇𝒶𝒾𝓃} ) , \qquad Eq . 4$$

where W is model parameters, S is the similarity matrix, and L is the task loss. The optimal model weights are learned on [symbol] given a similarity matrix S. Hence embodiments learn W*(S), which is dependent on S since W* depends on the loss function L(·) which is a function of S. S is not updated in this stage because this would overfit the BFTSS training set; instead S will be updated in the second stage according to embodiments.

In the second stage, the optimal similarity matrix S is learned, at process 310, on BFTSS validation set [symbol] given the optimal model weights W*(S) learned in the first stage on [symbol] The model trained in the first stage W*(S) is evaluated on [symbol] and S is updated by minimizing the validation loss. The following optimization problem is solved at this stage:

$${min}_{S} L ( {W}^{*} ( S ) , S , {𝒟}^{B - val} ) . \qquad Eq . 5$$

By performing both the stages iteratively with different parameters being fixed at each stage, embodiments advantageous avoid overfitting on the any of the two dataset [symbol] and [symbol] .

Combining both the stages, embodiments have the following bi-level optimization framework:

$${min}_{S} L ( {W}^{*} ( S ) , S , {𝒟}^{B - val} ) s . t . {W}^{*} ( S ) = {min}_{W} L ( W , S , {𝒟}^{B - train} ) \qquad Eq . 6$$

According to embodiments, from the bottom, the optimization problem corresponds to the learning stage W and then S. These two stages are conducted end-to-end. The solution obtained in the first stage W*(S) is a function of S. Embodiments solve for S by minimizing the validation loss in the second stage. The S learned in the second stage changes the training loss in the first stage, which changes the solution W*(S).

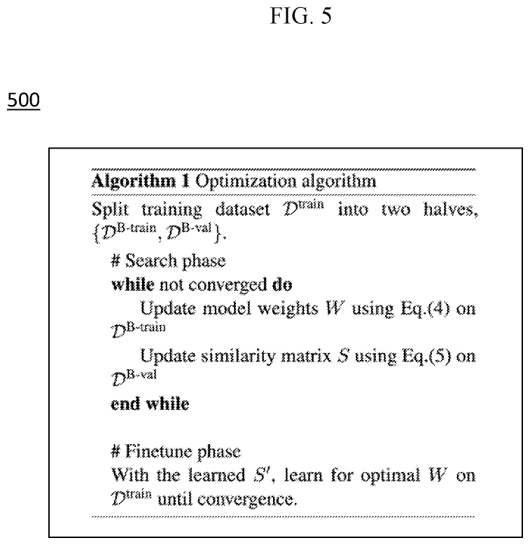

See the example 500 shown in FIG. 5 which similarly includes two distinct phases. 1) Search phase: In this phase, optimal similarity matrix S* is estimated by an iterative algorithm to solve the Bi-level optimization problem in Equation 6 noted above. The embodiment learns S′≈S*·2) at process 320. Finetune Phase: In this phase, embodiments finetune the language model on the whole [symbol] , at process 321, for optimal model weights W*with a fixed S′.

For optimization in the search phase, embodiments emply a gradient-based optimization process to solve the problem defined in Equation 6. For example, W is approximated using the one-step gradient descent:

$${W}^{*} ( S ) \approx {W}^{′} = W - {η}_{w} {∇}_{W} L ( W , S , {𝒟}^{B - train} ) \qquad Eq . 7$$

where W′ is plugged into the second-level objective function. The gradient with respect to the S matrix is calculated to update S:

$${S}^{*} \approx {S}^{′} = S - {η}_{s} {∇}_{S} L ( {W}^{′} , S , {𝒟}^{B - val} ) . \qquad Eq . 8$$

where gradient of the loss function with respect to $S$ is calculated using the chain rule. W′ is an implicit function of S.

$${∇}_{S} L ( {W}^{′} , S , {𝒟}^{ℬ - val} ) = {∇}_{s} L ( W - {η}_{w} {∇}_{w} L ( W , S , {𝒟}^{ℬ - train} ) , S , {𝒟}^{ℬ - val} ) = {∇}_{S} L ( {W}^{′} , S , {𝒟}^{ℬ - val} ) - {η}_{w} * {∇}_{S , W}^{2} L ( W , S , {𝒟}^{ℬ - train} ) {∇}_{{W}^{′}} L ( {W}^{′} , S , {𝒟}^{ℬ - val} ) \qquad Eq . 9$$

where solving for S′ involves an expensive matrix-vector product, whose computational complexity can be reduced by a finite difference approximation employed according to exemplary embodiments:

$${∇}_{S , W}^{2} L ( W , S , {𝒟}^{B - train} ) {∇}_{{W}^{′}} L ( {W}^{′} , S , {𝒟}^{B - train} ) = \frac{{∇}_{S} L ( {W}^{+} , S , {𝒟}^{B - t r a i n} ) - {∇}_{S} L ( {W}^{-} S {𝒟}^{B - t r a i n} )}{2 ∈} , \qquad Eq . 10$$

$$where$$

$${W}^{\pm } = W \pm ∈ {∇}_{{W}^{′}} L ( {W}^{′} , S , {𝒟}^{B - val} ) ,$$

$$∈ = \frac{0.01}{{‖ {∇}_{{W}^{′}} L ( {W}^{′} S , {𝒟}^{B - ν al} ) ‖}_{2}} .$$

According to embodiments, this procedure is carried out iteratively until convergence, at which time the Finetune phase starts. With the trained S′ from the concluded first phase, the whole model is further finetuned for optimal weights W (S′) on the entire training data in [symbol] with S′ fixed at process 311. This allows the model parameters to be tuned on the unseen [symbol] as well as [symbol] .

The dimension of S is V×V which is generally difficult to optimize when V is very large. Embodiments herein reduce the dimensionality of S, making it substantially more convenient to optimize. For example, two different ways to reduce the dimension of S from V×V to V×K where K<<V are provided:

BFTSS Top-K: After the S matrix initialization, embodiments choose the K words with the highest similarity scores and their corresponding indices from each row in the S matrix. The entries corresponding to the top-k words in each row of the S matrix are updated, thus reducing the dimension from V×V to V×K_{top-K} where K_{top-K}<<V.

BFTSS U-V: Initialize S as follows,

$$S = I + f ( {\{ Ê \}}^{d} ) = I + \hat{S} \qquad Eq . 11$$

where Ŝ=f({ [symbol] E}^{d}). S is a full rank matrix because of the added identity matrix, but Ŝ may not be a full-rank matrix according to embodiments. Ŝ can be decomposed into a product of two lower-rank matrices. Thus to efficiently reduce the dimension of the S matrix, embodiments apply rank reduction on Ŝ. And decomposition of Ŝ into two factors U and V∈R^{V×K}^{ᵤ₋ᵥ} of rank Kᵤ₋ᵥ<<V may be implemented such that,

$$S = I + f ( {\{ Ê \}}^{d} ) = I + \hat{S} \approx I + U \times {V}^{T} \qquad Eq . 12$$

According to embodiments, reconstruction of S matrix is not needed to perform soft embedding operations. The following operation is performed instead,

$$= {e}_{i}^{( t )} \times {S}^{( t )} \times {\{ {E}^{( t )} \}}^{T} = {\{ {E}_{i}^{( t )} \}}^{T} + h ( ( ( {e}_{i}^{( t )} \times U ) \times {V}^{T} ) \times {\{ {E}^{( t )} \}}^{T} ) , \qquad Eq . 13$$

where h is the Top-K operation which selects similar words dynamically contrary to the static selection in BFTSS Top-K.

Multiplication may be performed in a specific order to avoid reconstruction of S matrix every time for soft embeddings. (eᵢ^{(t)}×U)∈ [symbol] is a Kᵤ₋ᵥ-dimensional vector. V∈ [symbol] . Thus, it boils down to product of a Kᵤ₋ᵥ-dimensional vector with Kᵤ₋ᵥ×V dimensional matrix (VT), which is is then multiplied with the embedding matrix to get a H dimensional soft embedding vector. Thus the computational complexity is of the same order as BFTSS Top-K approach.

Embodiments herein achieve a technological advantage as further apparent from the following demonstration of comparative examples.

Experiments were performed on several datasets from GLUE. The GLUE datasets span a wide range of tasks such as linguistic acceptability (CoLA), semantic textual similarity (STS-B), paraphrase (QQP), natural language inference (RTE, QNLI, MNLI), and sentiment classification (SST-2). To simulate a low-resource finetuning scenario, 100, 300, and 1,000 examples are sampled from the original training dataset for training. The models are evaluated on the original development set. As shown below, trained embodiments herein achieve improved markers over other datasets in those linguistic acceptability (CoLA), semantic textual similarity (STS-B), paraphrase (QQP), natural language inference (RTE, QNLI, MNLI), and sentiment classification (SST-2), which may be input and output as tasks at S400 which may include aspects such as replace-ability, for example in determining a synonym replacement between one company name and others, as dependent on whether the task is “separate tech companies from gas companies” or “find companies with their headquarters in Washington state”, for example, the information of which pretrained language models or static lexical resources are not able to provide.

Previous methods for data augmentation implicitly assume that the similarity structure for a task is identical to a general similarity structure, which can be derived from pretrained models or gathered from external lexical semantic resources. However, similarity structures are task-specific with varying degrees of closeness to the general similarity structure, as shown in the Apple-Microsoft example above. In contrast, embodiments herein are, among other things, trained with task data to ensure the training can be task-specific.

Many different baselines are compared with the embodiments herein. For example, vanilla finetuning is a finetuning method where the whole training dataset is used for training. RecAdam is an advanced version of weight decay with time-varying coefficients for the cross-entropy loss term and the regularization loss term. Child-D and Child-F are methods where a mask is applied to the gradients to restrict the number of parameters being updated to avoid overfitting. Top-K-layer finetuning only updates the top K layers, and Mixout randomly replaces the updated parameters with the pretrained parameters. Finally EDA is a data augmentation method with a dependency on the knowledge resource WordNet.

All baselines were evaluated with the pretrained BERT-base and BERT-large models. They were fine-tuned on the subsampled training datasets. The averaged results on the original development set over ten random seeds are reported below. For BFTSS Top-K and BFTSS U-V, top 50 words and U-V dimension of 100 worked the best among other choices.

Table 1 shows the results of the average scores for the embodiments herein and baseline methods. Models trained according to embodiments herein are most accurate compared to the baselines over all the sampled data sizes for both BERT-base and BERT-large models, often by large margins. This improvement indicates that embodiments using bi-level optimization to learn a task-dependent similarity structure for finetuning without any external knowledge is very effective in boosting the model's performance over baselines. Among baseline methods, Mixout and Top-K-layer Tuning perform better than other baselines. However, there is still a substantial performance gap between these methods and our proposed methods. For example, BFTSS Top-K method achieves an average gain of 10.58%, 4.73%, and 1.50% over mixout in 100, 300, and 1 K training examples scenario, respectively, on the BERT-base model. Our BFTSS U-V method achieves an average gain of 10.75%, 4.77%, and 1.39% over mixout in 100, 300, and 1 K training examples scenario, respectively, on the BERT-base model. The trend is similar for BERT-large models and also when compared to Top-K-layer Tuning.

Because Mixout proposes to replace randomly sampled model parameters with pretrained model parameters while finetuning and Top-K-layer Tuning only tunes the Top-K layers while freezing the remaining bottom weights, they both can be considered as putting restrictions on model capacity to avoid overfitting. Different from these methods, the embodiments herein utilize information about unseen words in the form of a task-dependent similarity structure to serve as an informative prior for the model in finetuning. The model, especially the embeddings of the unseen words, receive informative updates from limited training data. Results here show that by providing more information about unseen words in the vocabulary instead of restricting the tunable parameters, models can be trained to have better generalization without overfitting.

TABLE 1

| Method | 100 | 300 | 1000 |
|---|---|---|---|
| Vanilla | 33.11 | 46.17 | 65.28 |
| RecAdam | 36.65 | 44.46 | 68.28 |
| Child-D | 38.38 | 52.65 | 66.88 |
| Child-F | 38.09 | 50.89 | 66.52 |
| Top-K-layer | 39.91 | 58.01 | 68.47 |
| Mixout | 43.97 | 58.28 | 68.80 |
| EDA | 52.95 | 56.95 | 62.92 |
| BFTSS Top-K | 54.55 | 63.01 | 70.30 |
| BFTSS U-V | 54.72 | 63.05 | 70.19 |

(a) Test Results (%) on all datasets with a BERT-base model.

| | | | |
|---|---|---|---|
| Vanilla | 38.70 | 56.80 | 69.31 |
| RecAdam | 36.53 | 56.92 | 70.16 |
| Child-D | 48.05 | 64.14 | 71.37 |
| Child-F | 47.51 | 63.05 | 70.18 |
| Top-K-layer | 51.86 | 64.94 | 72.05 |
| Mixout | 52.98 | 64.22 | 72.32 |
| EDA | 52.75 | 60.14 | 65.04 |
| BFTSS Top-K | 58.00 | 66.53 | 72.86 |
| BFTSS U-V | 58.10 | 66.50 | 73.11 |

(b) Test Results (%) on all datasets with a BERT-large model.

The reported numbers in Table 1 are the averaged evaluation metrics across all tasks with different number of samples training data examples. Bold indicates a highest number, and italic indicates a second highest.

Comparisons were also made to the data augmentation method, EDA. Different from the baselines above, an external lexical resource, WordNet, is used in EDA for synonym replacement. Embodiments herein outperform EDA in all datasplits despite having no access to any additional data. On the BERT-base model, the BFTSS Top-K method outperforms EDA by an average performance gain of 1.6%, 6.06%, and 7.38% in 100, 300, and 1000 training examples scenarios. Similarly, on the BERT-base model, the BFTSS U-V method outperforms EDA by an average performance gain of 1.77%, 6.1%, and 7.27% in 100, 300, and 1000 training examples scenarios. The trend is similar for the BERT-large models.

EDA can be seen as creating symbolic data augmentations by replacing words according to a general similarity structure coupled with other operations such as random swap, insertion and deletion. With increasing training examples, the accuracy improvement of our method over EDA increases. It was realized that this result indicates that initially, the general similarity structure is helpful due to low amount of training data compared to no augmentation at all. However, as the training data increases, the general similarity structure along with other heuristics brings more noise than information, resulting in smaller gains and even performance loss compared to Vanilla finetuning. The task-specific similarity structure according to embodiments herein can benefit the models in all cases, because it is close to the general similarity structure when the training data is small, and moves to a similarity structure tailored for the task when training data increases.

Finally, the two dimensionality reduction methods, Top-K and U-V, perform quite similarly under different conditions, which indicates that both dimensionality reduction methods provides similar benefits to model training.

Therefore, there is disclosed Bi-level Finetuning with Task-dependent Similarity Structure framework where all parameters, including the embeddings for unseen tokens, are finetuned with task-dependent information from the training data only, in which according to exemplary embodiments, a task-dependent similarity structure is learned in a data-driven fashion, which in turn is used to compose soft embeddings from conventional embeddings to be used in training to update all parameters. In order to learn the similarity structure and model parameters, there is disclosed a bi-level optimization algorithm with two stages-search and finetune—to ensure successful learning. Results of experiments on several classification datasets in low-resource scenarios demonstrate that models trained according to such embodiments outperform strong baselines. Ablation experiments further support the effectiveness of different components according to those embodiments.

Embodiments herein combine strengths of various approaches. For generalization ability to unseen data, all parameters, especially embeddings of words not in the training data, should participate in the finetuning according to embodiments, and at the same time, no external knowledge source should be required for such finetuning to ensure the method being scalable to different tasks. The ideal training framework for these goals should allow training signals to flow from tokens in training data to unseen tokens in a task-dependent way. Such a framework will ensure that the generalization ability of the trained model is strengthened through fine-tuning without the risk of overfitting quickly to a small amount of training data.

Embodiments herein disclose a Bi-level Finetuning with Task-dependent Similarity Structure (BFTSS) with aims to meet the above-noted goals. First, there is disclosed herein a low-resource finetuning method where all parameters of the model, including the embeddings of unseen tokens, can be tuned directly through soft embeddings. The soft embeddings are constructed through the use of a similarity matrix with pairwise similarity scores between words, termed a similarity structure in this paper. Second, there is disclosed herein a bi-level optimization algorithm to learn a task-dependent similarity structure with low-resource task data, where no extra data, knowledge source or task-dependent prior knowledge is required. Since the similarity structure is usually very large, two different methods are disclosed combined herein to reduce size and make the learning tractable. Finally, as noted above, comparison to baseline models and ablated models shows the effectiveness of the embodiments disclosed herein, where the performance of the models trained in the proposed method surpasses all baselines by large margins.

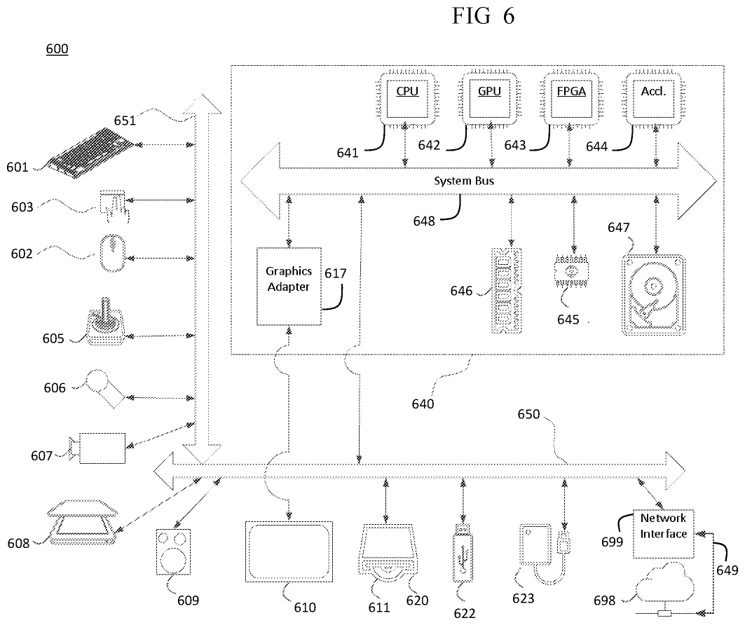

The techniques described above, can be implemented as computer software using computer-readable instructions and physically stored in one or more computer-readable media or by a specifically configured one or more hardware processors. For example, FIG. 6 shows a computer system 600 suitable for implementing certain embodiments of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 6 for computer system 600 are exemplary in nature and are not intended to suggest any limitation as to the scope of use or functionality of the computer software implementing embodiments of the present disclosure. Neither should the configuration of components be interpreted as having any dependency or requirement relating to any one or combination of components illustrated in the exemplary embodiment of a computer system 600.

Computer system 600 may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard 601, mouse 602, trackpad 603, touch screen 610, joystick 605, microphone 606, scanner 608, camera 607.

Computer system 600 may also include certain human interface output devices. Such human interface output devices may be stimulating the senses of one or more human users through, for example, tactile output, sound, light, and smell/taste. Such human interface output devices may include tactile output devices (for example tactile feedback by the touch-screen 610, or joystick 605, but there can also be tactile feedback devices that do not serve as input devices), audio output devices (such as: speakers 609, headphones (not depicted)), visual output devices (such as screens 610 to include CRT screens, LCD screens, plasma screens, OLED screens, each with or without touch-screen input capability, each with or without tactile feedback capability some of which may be capable to output two dimensional visual output or more than three dimensional output through means such as stereographic output; virtual-reality glasses (not depicted), holographic displays and smoke tanks (not depicted)), and printers (not depicted).

Computer system 600 can also include human accessible storage devices and their associated media such as optical media including CD/DVD ROM/RW 620 with CD/DVD 611 or the like media, thumb-drive 622, removable hard drive or solid state drive 623, legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system 600 can also include interface 699 to one or more communication networks 698. Networks 698 can for example be wireless, wireline, optical. Networks 698 can further be local, wide-area, metropolitan, vehicular and industrial, real-time, delay-tolerant, and so on. Examples of networks 698 include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks 698 commonly require external network interface adapters that attached to certain general-purpose data ports or peripheral buses (650 and 651) (such as, for example USB ports of the computer system 600; others are commonly integrated into the core of the computer system 600 by attachment to a system bus as described below (for example Ethernet interface into a PC computer system or cellular network interface into a smartphone computer system). Using any of these networks 698, computer system 600 can communicate with other entities. Such communication can be uni-directional, receive only (for example, broadcast TV), uni-directional send-only (for example CANbusto certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core 640 of the computer system 600.

The core 640 can include one or more Central Processing Units (CPU) 641, Graphics Processing Units (GPU) 642, a graphics adapter 617, specialized programmable processing units in the form of Field Programmable Gate Areas (FPGA) 643, hardware accelerators for certain tasks 644, and so forth. These devices, along with Read-only memory (ROM) 645, Random-access memory 646, internal mass storage such as internal non-user accessible hard drives, SSDs, and the like 647, may be connected through a system bus 648. In some computer systems, the system bus 648 can be accessible in the form of one or more physical plugs to enable extensions by additional CPUs, GPU, and the like. The peripheral devices can be attached either directly to the core's system bus 648, or through a peripheral bus 651. Architectures for a peripheral bus include PCI, USB, and the like.

CPUs 641, GPUs 642, FPGAs 643, and accelerators 644 can execute certain instructions that, in combination, can make up the aforementioned computer code. That computer code can be stored in ROM 645 or RAM 646. Transitional data can be also be stored in RAM 646, whereas permanent data can be stored for example, in the internal mass storage 647. Fast storage and retrieval to any of the memory devices can be enabled through the use of cache memory, that can be closely associated with one or more CPU 641, GPU 642, mass storage 647, ROM 645, RAM 646, and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, the computer system having architecture 600, and specifically the core 640 can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core 640 that are of non-transitory nature, such as core-internal mass storage 647 or ROM 645. The software implementing various embodiments of the present disclosure can be stored in such devices and executed by core 640. A computer-readable medium can include one or more memory devices or chips, according to particular needs. The software can cause the core 640 and specifically the processors therein (including CPU, GPU, FPGA, and the like) to execute particular processes or particular parts of particular processes described herein, including defining data structures stored in RAM 646 and modifying such data structures according to the processes defined by the software. In addition or as an alternative, the computer system can provide functionality as a result of logic hardwired or otherwise embodied in a circuit (for example: accelerator 644), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

While this disclosure has described several exemplary embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

What is claimed is:

1. A method for language processing, the method performed by at least one processor and comprising:
constructing similarity scores between words;
initializing a similarity structure which is task-dependent and based on the similarity scores; and
machine learning a task-dependency of the similarity structure by implementing bi-level optimization comprising:
a search phase comprising learning model weights by estimating a parameter of a model, respective to a first entry of the similarity structure, and learning a parameter of a second entry of the similarity structure by using the parameter on the second entry; and
a fine-tuning phase comprising updating the parameter of the model while holding the similarity structure fixed.

2. The method according to claim 1,
wherein the words are of a vocabulary of a predetermined size,
wherein the similarity structure comprises a similarity matrix having a plurality of rows each being respective to one of the words, a number of the rows being of the predetermined size, and
wherein each of entries, including the first entry and the second entry, to the rows indicates a proximity of the respective ones of the words to each of other ones of the words.

3. The method according to claim 2,
wherein estimating the parameter of the model comprises learning optimal model weights W*(S) based on:
$${W}^{*} ( S ) = {min}_{W} L ( W , S , {𝒟}^{B - train} ) ,$$
where W is the model parameter, S is the similarity matrix, L is a task loss, and [symbol] is a training set.

4. The method according to claim 3,
wherein the similarity matrix S is not updated while learning the optimal model weights W*(S).

5. The method according to claim 4,
wherein, after learning the optimal model weights W*(S), the similarity matrix S is updated by:
$${min}_{S} L ( {W}^{*} ( S ) , S , {𝒟}^{B - val} ) ,$$
where [symbol] is a validation set.

6. The method according to claim 1, further comprising, after initializing the similarity structure, reducing a dimension of the similarity structure based on a number of the words determined to have highest similarity scores as compared to other ones of the words.

7. The method according to claim 1, further comprising, after initializing the similarity structure, reducing a dimension of the similarity structure by decomposing the similarity matrix into a product of a plurality of matrices.

8. The method according to claim 1,
wherein initializing the similarity structure comprises adding an inner product of an embedding matrix to another matrix, and
wherein the embedding matrix comprises a hidden dimension of an embedding layer of a language model comprising the embedding matrix.

9. The method according to claim 1,
wherein initializing the similarity structure comprises deriving soft embeddings of the words, and
wherein the soft embeddings comprise linear combinations of embedding vectors having weights determined based on the similarity structure.

10. The method of claim 1, further comprising:
receiving a task; and
answering the task based on the task-dependency of the similarity structure machine-learned by implementing the bi-level optimization.

11. A apparatus for language processing, the apparatus comprising:
at least one memory configured to store computer program code;
at least one processor configured to access the computer program code and operate as instructed by the computer program code, the computer program code including:
constructing code configured to cause the at least one processor to construct similarity scores between words;
initializing code configured to cause the at least one processor to initialize a similarity structure which is task-dependent and based on the similarity scores; and
machine learning configured to cause the at least one processor to machine learn a task-dependency of the similarity structure by implementing bi-level optimization comprising:
a search phase comprising learning model weights by estimating a parameter of a model, respective to a first entry of the similarity structure, and learning a parameter of a second entry of the similarity structure by using the parameter on the second entry; and
a fine-tuning phase comprising updating the parameter of the model while holding the similarity structure fixed.

12. The apparatus according to claim 11,
wherein the words are of a vocabulary of a predetermined size,
wherein the similarity structure comprises a similarity matrix having a plurality of rows each being respective to one of the words, a number of the rows being of the predetermined size, and
wherein each of entries, including the first entry and the second entry, to the rows indicates a proximity of the respective ones of the words to each of other ones of the words.

13. The apparatus according to claim 12,
wherein estimating the parameter of the model comprises learning optimal model weights W*(S) based on:
$${W}^{*} ( S ) = {min}_{W} L ( W , S , {𝒟}^{B - train} ) ,$$
where W is the model parameter, S is the similarity matrix, L is a task loss, and [symbol] is a training set.

14. The apparatus according to claim 13,
wherein the similarity matrix S is not updated while learning the optimal model weights W*(S).

15. The apparatus according to claim 14,
wherein, after learning the optimal model weights W*(S), the similarity matrix S is updated by:
$${min}_{S} L ( {W}^{*} ( S ) , S , {𝒟}^{B - val} ) ,$$
where [symbol] is a validation set.

16. The apparatus according to claim 11, wherein the computer program code further comprises reducing code configured to cause the at least one processor to, after initializing the similarity structure, reduce a dimension of the similarity structure based on a number of the words determined to have highest similarity scores as compared to other ones of the words.

17. The apparatus according to claim 11, wherein the computer program code further comprises reducing code configured to cause the at least one processor to, after initializing the similarity structure, reduce a dimension of the similarity structure by decomposing the similarity matrix into a product of a plurality of matrices.

18. The apparatus according to claim 11,
wherein initializing the similarity structure comprises adding an inner product of an embedding matrix to another matrix, and
wherein the embedding matrix comprises a hidden dimension of an embedding layer of a language model comprising the embedding matrix.

19. The apparatus according to claim 11,
wherein initializing the similarity structure comprises deriving soft embeddings of the words, and
wherein the soft embeddings comprise linear combinations of embedding vectors having weights determined based on the similarity structure.

20. A non-transitory computer readable medium storing a program causing a computer to execute a process, the process comprising:
constructing similarity scores between words; and
initializing a similarity structure which is task-dependent and based on the similarity scores;
machine learning a task-dependency of the similarity structure by implementing bi-level optimization comprising:
a search phase comprising learning model weights by estimating a parameter of a model, respective to a first entry of the similarity structure, and learning a parameter of a second entry of the similarity structure by using the parameter on the second entry; and
a fine-tuning phase comprising updating the parameter of the model while holding the similarity structure fixed.
